(19) United States
(12) Patent Application Publication
(10) Pub. No.: US 2005/0023357 A1
(43) Pub. Date: Feb. 3, 2005

(54) Bar code scanner with lighting device for illumination

(76) Inventor: Chris Yeh, Hsin-Tien City (TW)

Correspondence Address: Yi-Wen Tseng, 509 ROOSEVELT BLVD. #D306, FALLS CHURCH, VA, 22044, US

(21) Appl. No.: 10/629,630

(22) Filed: Jul. 30, 2003

(51) Int. Cl. G06K 7/10

(52) U.S. Cl. 235/462.43

(57) ABSTRACT

A bar code scanner with lighting device for illumination is disclosed, The bar code scanner includes a case plate, a housing, a main body and a lighting device. The housing has an opening formed in the front end thereof. The main body has a circuit board, a scanning unit and a scanning window. The main body is accommodated in the housing with the case plate covered thereon. The lighting device electrically connected with the circuit board to provide the illumination for reading a bar code pattern. Therefore, it is more convenient for the operation of the bar code scanner in an insufficiently lighting environment.

### BACKGROUND OF THE INVENTION

The present invention relates generally to a lighting structure in a bar code scanner and, more particularly, to a bar code scanner having a lighting device for illuminating the surroundings to facilitate a bar code reading.

A bar code symbol appearing on a label or on the surface of an article is convenient for a bar code scanner (reader) to perform information or characters recognition in applications of inventory control, point-of-sale processing, transportation and logistics, distribution, and the like. The bar code symbol itself is a coded pattern of graphic indicia comprised of a series of bars of various widths spaced apart from one another to bound spaces of various widths, the bars and spaces having different light reflecting characteristics.

Please refer to FIG. 1, a conventional bar code scanner 10a includes a housing 11a, a scanning unit 12a, a microprocessor 13a, a memory unit 14a and an output unit 15a. The housing 11a forms generally as a rectangular body and the scanning unit 12a is formed in the front end of the housing 11a. The scanning unit 12a of the reader 10a electro-optically transforms the spatial pattern represented by the graphic indicia into a time-varying electrical signal, which is in turn decoded by the microprocessor 13a into data which represent the information or characters encoded in the indicia that are intended to be descriptive of the article or some characteristic thereof. Such data is typically represented in digital form to be stored in the memory unit 14a, and is utilized as an input to a data processing system, such as a computer, by the output unit 15a.

However, the conventional bar code scanner is provided merely for reading the bar code. Normally in a storehouse, the products are stacked higher and closer; therefore, the illumination may be not strong enough to operate the bar code scanner, and there may require a flash light for auxiliary lighting. Obviously, it is inconvenient for a user to operate both at the same time. In another situation, the bar code scanners may be also used in dark or less-light environment.

Therefore, there exist inconvenience and drawbacks for practically application of the above conventional bar code scanners. There is thus a substantial need to provide an improved lighting structure in the bar code scanner that resolves the above drawbacks and can be used more conveniently and practically.

### BRIEF SUMMARY OF THE INVENTION

The object of the present invention is to provide a bar code scanner having a lighting device for providing an auxiliary illumination when the bar code scanner is operated in an insufficiently illuminating environment.

Another object of the present invention is to provide a bar code scanner with a lighting device which can be turned on/off by an individual switch.

In order to achieve the above-mentioned objects, the present invention provides a bar code scanner for reading a bar code pattern, which includes a housing with an opening formed in the front end thereof; a main body having a circuit board, a scanning unit and a scanning window, being mounted in the housing with the scanning window located in the opening, a case plate covered on the housing; and a lighting device electrically connected with the circuit board to provide an illumination for reading the bar code pattern.

Therefore, the present invention installs a light emitting diode and a switch on a push handle of a car cigarette lighter, such that when the lighter is conducted, the user or driver can easily observe the conducting status by the light generated by the light emitting diode.

### BRIEF DESCRIPTION OF THE DRAWINGS

These, as well as other features of the present invention, will become more apparent upon reference to the drawings wherein:

FIG. 1 shows a lateral view of a conventional bar code scanner;

FIG. 2 shows an exploded view of a bar code scanner with a lighting device for illumination according to a first preferred embodiment of the present invention;

FIG. 3 shows a magnified view of part A in FIG. 2;

FIG. 4 shows the assembly of the bar code scanner in FIG. 2;

FIG. 5 shows an exploded view of a scanning window and a lighting device according to a second preferred embodiment of the present invention;

FIG. 6 shows the assembly of the scanning window and the lighting device in FIG. 5; and

FIG. 7 shows a perspective view of a bar code scanner with a lighting device according to a third preferred embodiment of the present invention.

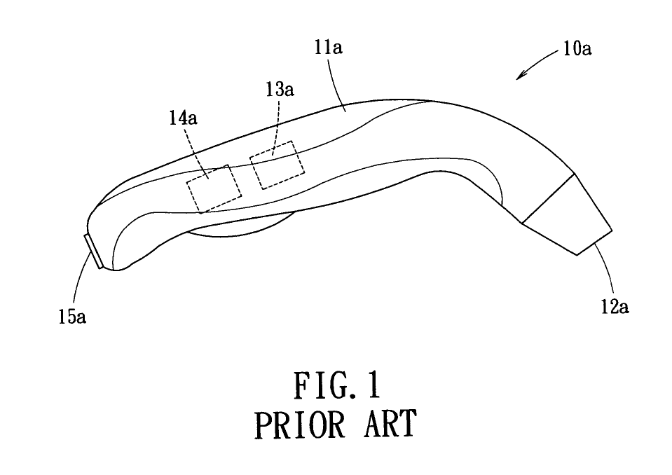

### DETAILED DESCRIPTION OF THE INVENTION

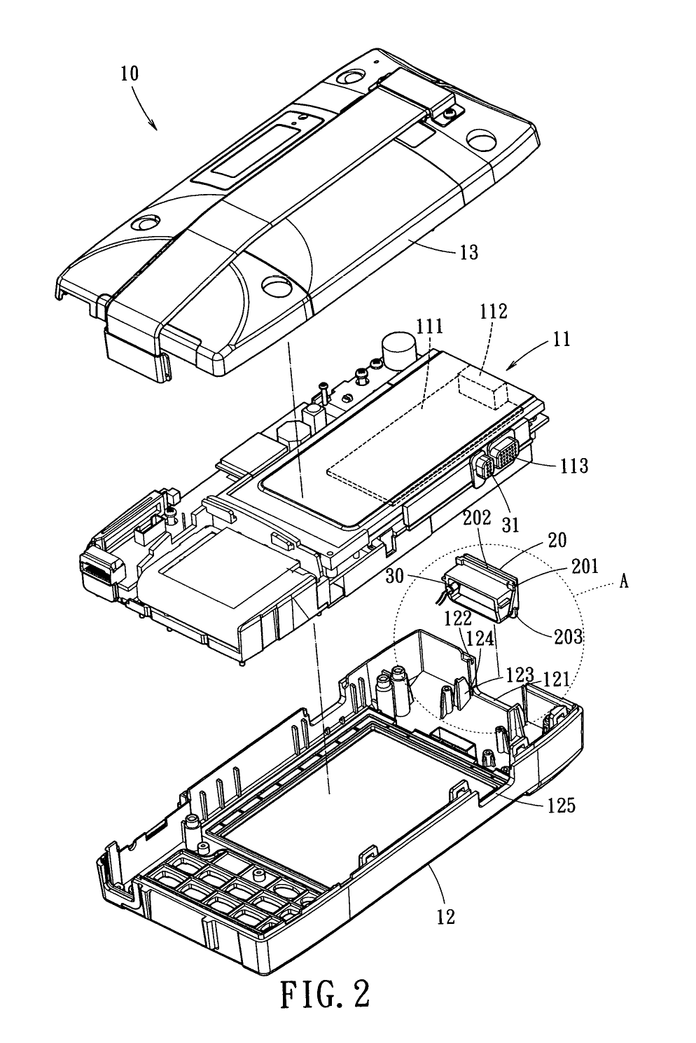

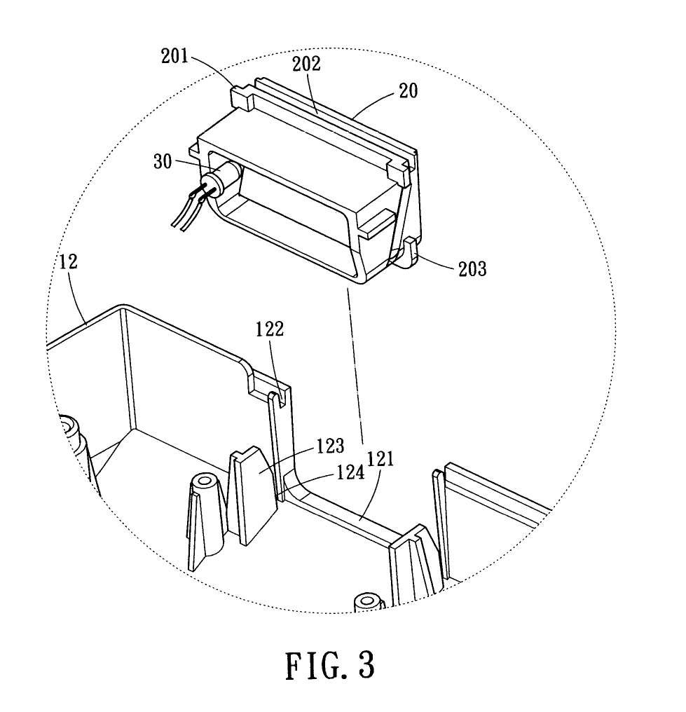

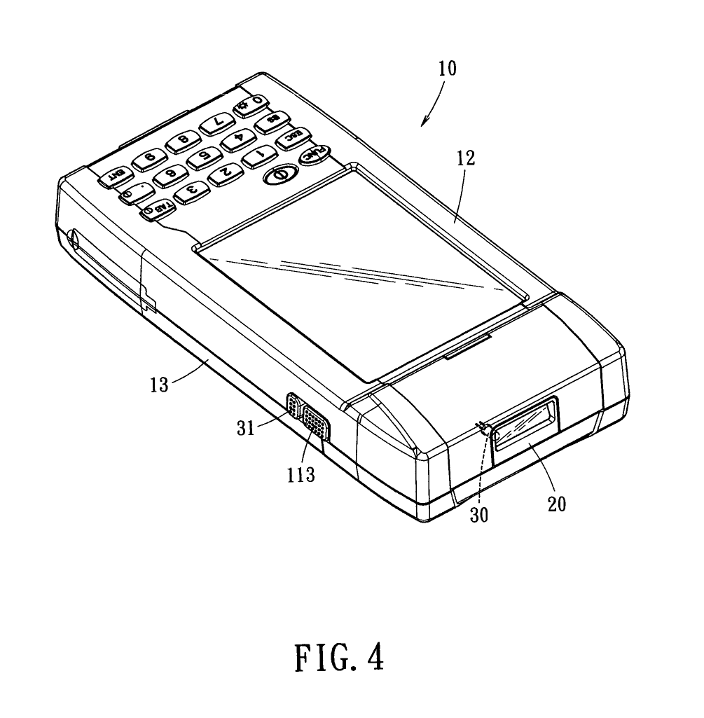

Referring to FIGS. 2 to 4, a first preferred embodiment of a lighting structure in bar code scanners according to the present invention includes a bar code scanner 10, a scanning window 20 and a lighting device 30.

The bar code scanner 10 includes a main body 11, a housing 12 and a case plate 13. The main body 11 is accommodated in the housing 12 with the case plate 13 covered thereon. The main body 11 includes a circuit board 111, a scanning unit 112 formed in the front end, and a scan actuating button 113 on each lateral side thereof.

The housing 12 has a substantially rectangular shape, and has an opening 121 on the front end thereof. Two opposite cavities 122 are formed adjacent the top portion of the opening 121, respectively. While the main body 11 is mounted in the housing 12, the scanning unit 112 can face the opening 121 for reading the bar code pattern. Moreover, two opposite ribs 123 are located right behind two sides of the opening 121, respectively. There is a gap 124 between each rib 123 and the opening 121. Each slot 125 formed on two lateral sides of the housing 12 is for a corresponding scan actuating button 113 located therein and allows a movement when the scan actuating button 113 is operated.

The scanning window 20 includes a strip plate 201 on the top surface with two extended ends seating on the cavities 122, respectively, and a protrusion 203 on each lateral side for fitting in the corresponding gap 124 when the scanning window 20 is mounted in the opening 121. There is a groove 202 formed in the strip plate 201 for receiving the front edge of the case plate 10.

The lighting device 30 is preferably a light emitting diode (LED), which is electrically connected with the circuit board 111 of the main body 11, and has a parallel connection with the scanning unit 112. Furthermore, a switch 31 can be connected to the lighting device 30 to provide an independently turning on/off control thereof. The lighting device 30 can be directly fixed on the circuit board 111 so that the lighting device 30 is located inside the frame of the scanning window 20 to emit light toward the scanning bar code pattern.

Accordingly, when the light is insufficient for operating the bar code scanner of the present invention, the lighting device 30 can be used to provide the auxiliary illumination. In the preferred embodiment, the lighting device 30 is turn on simultaneously when the scan actuating button 113 is pushed to start working of the scanning unit 112. Furthermore, the switch 31 can be selectively pushed to turn off the lighting device 30; therefore, the user can decide to turn on or off the lighting device 30 according to the environment while reading the bar code pattern. As such, it can also save the power.

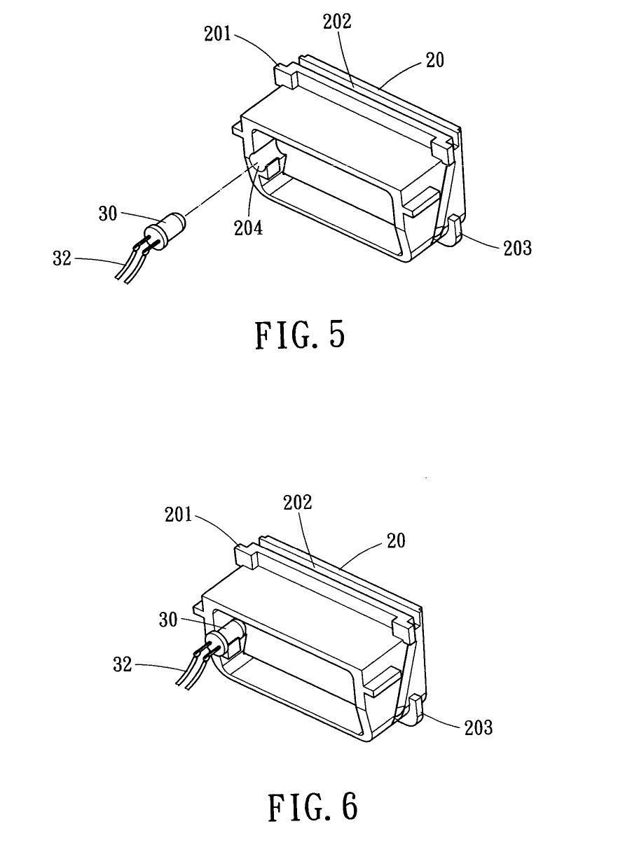

Referring to FIGS. 5 and 6, a second preferred embodiment of the present invention is shown. There is a semicircle-shaped seat 204 formed inside the flame of the scanning window 20′ for the lighting device 30 mounted thereon. The lighting device 30 further includes a wire 32 for connecting to the circuit board 111 of the main body 11.

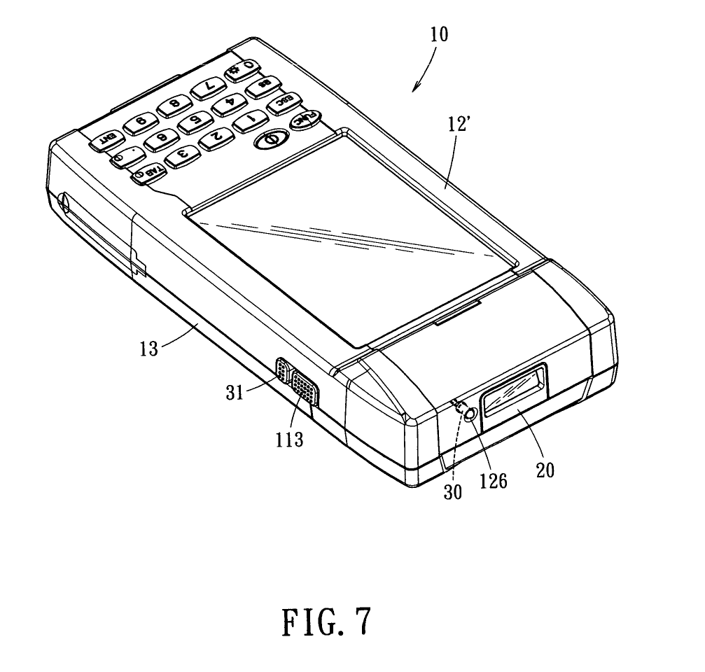

FIG. 7 shows a third preferred embodiment of the present invention. There is a through hole 126 formed on the front end of the housing 12′ for receiving the lighting device 30. Similarly, the wire 32 of the lighting device 30 is connected between the lighting device 30 and the circuit board 111 of the main body 11.

According to the lighting structure in bar code scanners of the present invention, it has at least the advantages as follows.

1. A built-in lighting device in the bar code scanner provides the extra and auxiliary illumination; therefore, it is more convenient for the operation of the bar code scanner in an insufficiently lighting environment.

2. The switch is provided to selectively control the lighting device; therefore, the user can further turn on or off the lighting device according to the environment while reading the bar code pattern so as to save the power.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

1. A bar code scanner for reading a bar code pattern, comprising:
a housing with an opening formed in the front end thereof;
a main body including a circuit board, a scanning unit and a scanning window, being mounted in the housing with the scanning window located in the opening;
a case plate covered on the housing; and
a lighting device electrically connected with the circuit board to provide an illumination for reading the bar code pattern.

2. The bar code scanner of claim 1, wherein the housing includes a through hole in the front end thereof for the lighting device mounted therein.

3. The bar code scanner of claim 1, wherein the scanning window includes a seat for the lighting device mounted thereon.

4. The bar code scanner of claim 3, wherein the seat is a semicircle-shaped groove.

5. The bar code scanner of claim 1, wherein the lighting device is a light emitting diode.

6. The bar code scanner of claim 1, wherein the lighting device has a parallel connection with the scanning unit.

7. The bar code scanner of claim 1, further comprising a switch for selectively controlling on/off of the lighting device.
